(19) United States
(12) Patent Application Publication
(10) Pub. No.: US 2008/0037364 A1
(43) Pub. Date: Feb. 14, 2008

(54) Method and Device for Pneumatic Treatment of Powder Materials

(76) Inventors: Frederic Dietrich, Morrens (CH); Yves Dietrich, Chevilly (CH)

Correspondence Address: BACHMAN & LAPOINTE, P.C., 900 CHAPEL STREET, SUITE 1201, NEW HAVEN, CT, 06510, US

(21) Appl. No.: 10/592,900

(22) PCT Filed: Mar. 11, 2005
(86) PCT No.: PCT/EP05/02643

§ 371 Date: Jan. 25, 2007

(30) Foreign Application Priority Data
Mar. 15, 2004 (DE) 10 2004 012 772.7
May 3, 2004 (DE) 10 2004 021 612.6

(51) Int. Cl. B01F 3/18; B01F 5/00; B01F 5/10; B65G 53/16

(52) U.S. Cl. 366/148; 366/165.1

(57) ABSTRACT

The invention relates to a method for pneumatic treatment of powder materials in a recipient chamber (22), with introduction of two material streams into the above through two inlet tubes (40, 40ₐ), optionally in a counter-current and/or approximately tangential sense and swirled in the recipient chamber (22). The material streams are for introduction at roughly the same level in the container and the tracks thereof are interleaved. The material streams are also introduced at an inclination angle (w) to a radial plane (E) of the recipient chamber (22) which is inclined downwards.

The invention relates to a method according to the precharacterizing clause of patent claim 1 and to a device for pneumatic treatment of powder materials with a container connected to a feed line and a discharge for the material being conveyed.

EP 0 538 711 A reveals a conveying device, for example for plastic granules, with a hose line which, at one end, enters a storage silo by means of a lance and, at the other end, projects through a filter cartridge into a connecting branch which sits on the box-like inflow of a tangential feed opening of a plasticizing cylinder. A cover subassembly, through which the hose line likewise passes, is provided with a suction chamber via the filter cartridge. Said suction chamber has suction openings directed toward the connecting branch and is operatively connected to a nozzle system, to which compressed air or compressed gas can be supplied as the working medium. A relatively high negative pressure is generated in the suction chamber and propagates through the suction openings and the filter into the connecting branch and from there through the suction line into the storage silo. The working medium is intended to generate such a high pressure, by means of an increase in its speed, in the material being conveyed that the solid materials are sucked, by mixing with a suction air stream, to said box-like inflow. At the filters, the solid materials are separated from the suction air stream and the latter is mixed with the working medium. Cleaning of the filter can not be carried out during the process.

EP 0 574 596 A describes a system for the pneumatic transfer of cement from ships into silos by means of a “sluice-type container” comprising a plurality of container segments; an exhaust air filter sits in the uppermost container segment and the lowermost container segment tapers in the manner of a funnel.

Powder materials are also conveyed and transported in a controlled atmosphere in the chemical, pharmaceutical and foodstuffs industry. The known systems for conveying powder materials of this type are generally coordinated in terms of construction to the product to be subsequently conveyed; these systems are individual manufacturing systems causing high system costs.

The pouring of powder into reaction vessels or reactors within explosive zones takes place in general manually via a sluice or a protective valve, since most reactors do not have the necessary space for an adequate loading system. Such a manner of operation does not comply with the existing safety rules for preventing the risk of explosion; if the reactor is inerted, the manual pouring in of powders from the manhole leads to atmospheric pressures and neutralizes the protective effect of the inert gas. If solid materials are entered manually, the inerting is neutralized within a short time (O₂ concentration>8%) and is not produced again even after relatively prolonged N₂ flushing during operation.

In recognition of these circumstances, the inventor has set himself the aim of permitting cost-effective mixing and conditioning of powder materials.

The teaching of the independent claim leads to this object being achieved; the subclaims indicate favorable developments. In addition, all of the combinations of at least two of the features disclosed in the description, the drawing and/or the claims lie within the scope of the invention. In the case of dimensional ranges indicated, values lying within the abovementioned limits are also to be disclosed as limit values and are to be usable as desired.

According to the invention, two material streams are supplied—in particular in opposite directions—to the container chamber through at least two supply tubes and are swirled in the container chamber. For this purpose, it has proven expedient for the material streams to be supplied approximately tangentially, preferably, in addition, at approximately the same container height, so that their tracks are interleaved. Intimate swirling is thereby produced.

For this purpose, the material streams are preferably also conducted in at an angle of inclination to a radial plane of the container, i.e. the material streams are introduced in a downwardly directed manner.

According to one of the possibilities for carrying out the method according to the invention, each of the material streams is removed from a common vessel and a circular movement thus produced. For this purpose, the swirled material streams are to be introduced from the container chamber into the common vessel and are to be removed therefrom together.

Another procedure—which can also be combined with the above method—is also to remove each of the material streams from a separate vessel. In the last-mentioned case, preferably different materials are mixed with one another.

A further favorable procedure lies within the scope of the invention, in which the material stream is conducted through at least two hollow profiles connected axially one behind the other and, in the latter, is guided past temperature-generating devices. In this case, according to the invention, the material stream is heated and dried in the outlet region of the hollow profile.

A device lies within the context of the invention, which device is to be used above all when carrying out the above methods and in which at least two supply lines are provided for a respective material stream and said supply lines are connected to a respective connecting branch; according to one feature of the invention, these connecting branches open in the same direction into the container interior, so that the material streams leaving them encounter one another and thus carry out the swirling.

It has proven favorable to provide at least two connecting branches which are approximately parallel to each other on the container and for them to preferably be assigned to a common radial plane; in an advantageous manner, they are to enclose an angle of inclination with the radial plane toward the container axis and/or are to be inclined downward toward the container interior. It has also proven favorable for the connecting branches to open somewhat offset in height with respect to each other into the container interior.

The container preferably sits with its lower end on a collecting vessel and is provided at the other end with a connecting branch.

It is preferred to join the vessel interior of the collecting vessel in the topward direction to at least one bottom aperture of the container and to provide it with a bottomward outflow element. At least one reflection device can be arranged in the flow path in the vessel interior as an impact element, against which the particles impact and are pushed back into the stream.

According to the invention, the bottomward outflow element has at least two output elements for a respective line—connected at the other end to one of the attachment branches; said line is intended, according to a further feature of the invention, to connect the outflow element of the reaction vessel to an attachment branch of the container, i.e. to connect a circular movement.

In a further refinement, a branch line is connected to the line; this branch line is then connected at the other end to a vessel which contains one of the powder materials.

Another device according to the invention serves to change the temperature of the material being conveyed, in the case of which device at least one temperature-generating device, preferably a hot-air-generating device, crossing the conveying track of the material being conveyed, is arranged in the interior of the container. In this case, at least two tubular hollow profiles of uniform cross section are advantageously to be joined axially to each other by an intermediate chamber, and the hot-air-generating device is to be arranged in the intermediate chamber; said hot-air-generating device is preferably inclined with respect to the longitudinal axis of the device.

It has proven favorable to allow the lower hollow profile to end at a bottom chamber which is connected to the upper hollow profile by a conveying line in order to permit circulation.

The object as seen by the inventor is achieved in a brilliant manner by the invention; the system according to the invention provides:
a closed, self-filling mixing system with a high degree of containment;
very efficient mixing, i.e. significantly lower mixing times in comparison to conventional systems;
the possibility of mixing different powders in very different ratios (1/10 000);
operation with the exclusion of an oxygen atmosphere and with little consumption of nitrogen;
complete emptying of the system with the possibility of cleaning in situ;
the direct addition of relatively small amounts of product to the mixture without interrupting the process;
the possibility of allowing powder properties to be changed during the mixing operation;
the design of fixed systems with which powder can be sucked up from various containers (barrels, big-bags, silos, etc.)
the sucking up of powder over considerable distances;
the use of extremely operationally reliable and only few movable parts with low maintenance.

Further advantages, features and details of the invention emerge from the following description of preferred exemplary embodiment and with reference to the drawing; in the latter:

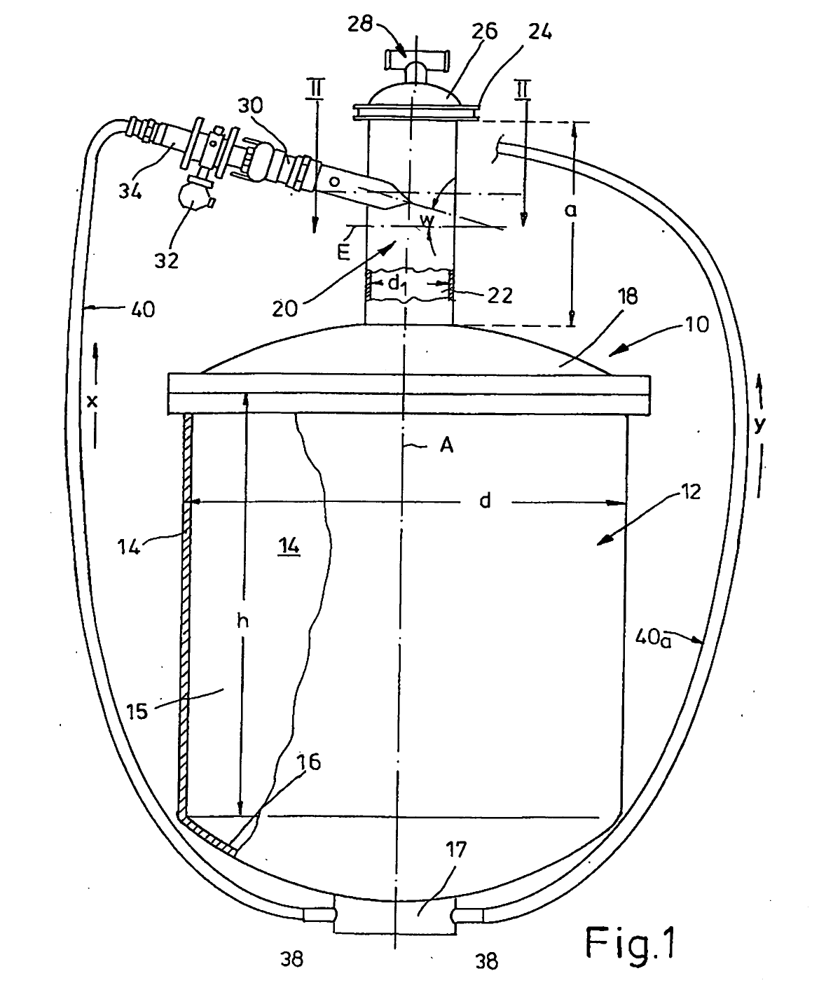

FIG. 1 shows a device according to the invention in a partially cutaway side view;

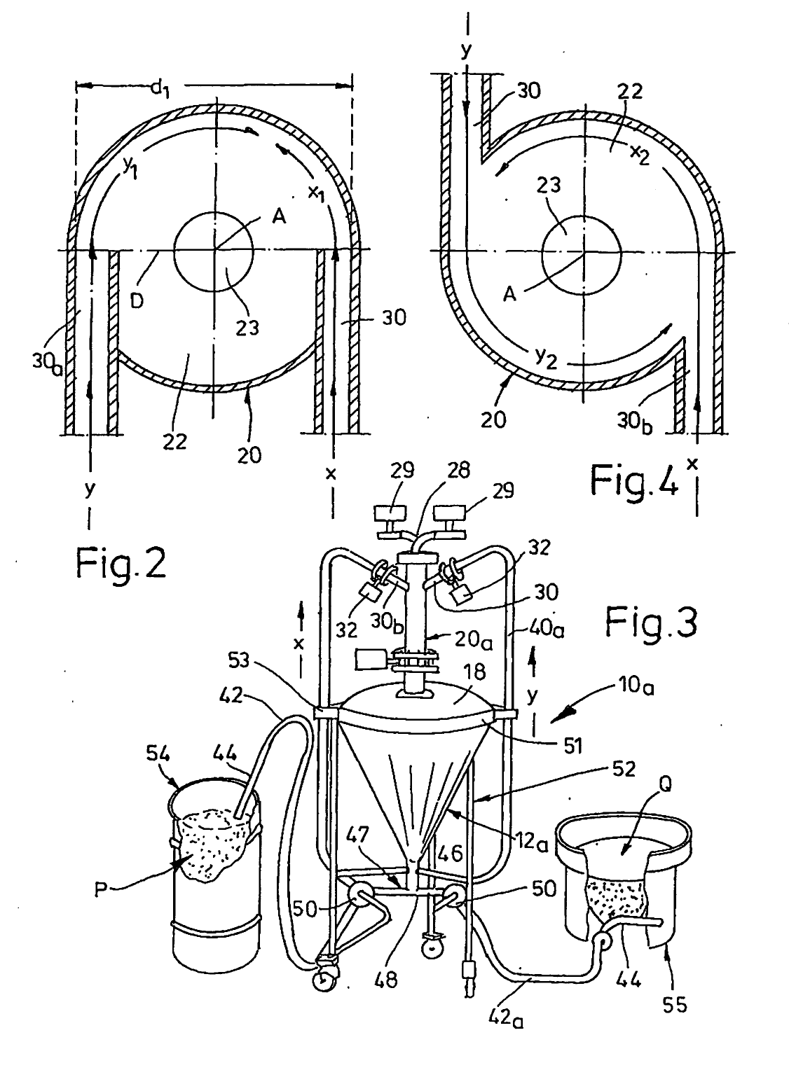

FIG. 2 shows the enlarged cross section through FIG. 1 along its line II-II;

FIG. 3 shows a further embodiment in a partially cutaway oblique view;

FIG. 4 shows an enlarged cross section, corresponding to the position of line II-II in FIG. 1, through FIG. 3;

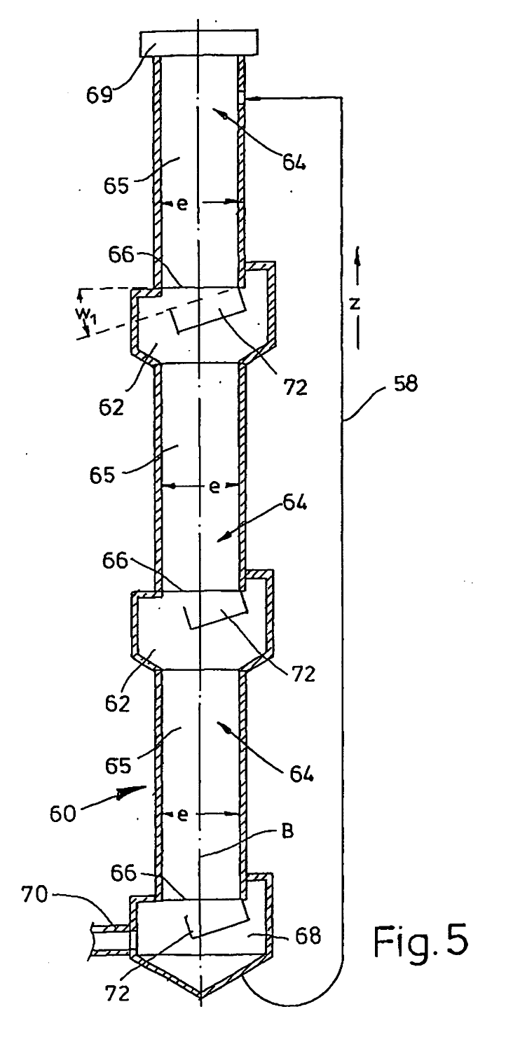

FIG. 5 shows another device according to the invention in a schematized, cutaway front view.

A device 10 for pneumatic conveying of powder materials of a small range of grain sizes has a collecting vessel 12 as main container with a cylindrical vessel wall 14 of height h and outer diameter d. The interior 15 of the collecting vessel 12 is closed downward by a housing bottom 16 from which a bowl-like bottom branch 17 protrudes along the vessel axis A.

The vessel interior 15 is covered by a dome-type cover 18 from which—axially with respect to the vehicle axis A—a cylindrical container 20 of electrolytically polished stainless steel of length a of, for example, 600 mm rises up; the interior 22 thereof of diameter d₁ of, here, 200 mm serves as the swirling chamber. This container interior 22 is covered by a plate-like sieve 24 above which a—here T-shaped—connecting branch 28 rises from a container cover 26. A vacuum line can be connected to said connecting branch at one end and a conveying gas line can be connected thereto at the other end, with at least the latter containing a shut-off valve. Valves of this type are indicated by way of example at 29 in FIG. 3.

Two lateral attachment branches 30, 30ₐ which run in an inclined manner—according to FIG. 2 parallel to each other at both ends of a common diametric—downward toward the vessel axis A—at an angle w of, here, approximately 15° to a radial plane E—lead into the container interior 22. A respective butterfly valve 32 is integrated as shut-off element in a connecting flange 34 in these attachment branches 30, 30ₐ.

From each of the supply tubes or attachment branches 30, 30ₐ, a hose-like line 40 or 40ₐ leads to a respective radial tube 38 of said bowl-like bottom branch 17. Furthermore, for the sake of better clarity, only part of the line 40ₐ situated on the right in FIGS. 1, 3 is illustrated.

Two streams of powder materials are conducted tangentially in the conveying direction x or y through the attachment branches 30, 30ₐ and the lines 40, 40ₐ to the interior 22 of the container 20 and, according to FIG. 2, are transferred on the inner surface of the container 20 into circular tracks x₁ and y₁ running in opposite directions. A swirling of the materials and the intimate mixing thereof are therefore produced. This mixture enters the vessel interior 15 owing to a central bottom aperture 23—of closable design.

In the exemplary embodiment 10ₐ according to FIG. 3, the collecting vessel 12ₐ-which is suspended in a supporting ring 51 of an undercarriage 52—is of funnel-like design, and its tip 46 merges into an T-shaped tube connection 47, to the cross tube 48 of which the two lines 40, 40ₐ are connected. Said lines are secured in holding loops 53 of said supporting ring 51. A respective intermediate piece is integrated here into each of the lines 40, 40ₐ as a sluice-type insert 50 to which a branch line 42 or 42ₐ is connected; said branch line ends at the other end with an insert tip 44 or 44ₐ of rigid material.

The insert points 44 and 44ₐ of the branch lines 42 and 42ₐ are respectively submerged into vessels 54, 55 which contain different powders P, Q; the latter are supplied through the lines 40/42 and 40ₐ/42ₐ to the swirling operation in the container interior 22. In this configuration—as can be seen above all in FIG. 4—the parallel attachment branches 30, 30_{b} are arranged in opposite directions, so that the circular tracks x₂, y₂ of the material streams x, y are directed in the same direction. The swirling arises here by the circular tracks x₂, y₂ encountering each other laterally.

By means of a switching-over operation into the intermediate pieces 50 of the lines 40, 40ₐ, the latter are temporarily separated from their branch lines 42, 42ₐ, and a circular movement arises between the vessel interior 15 and the interior 22 of the container 20 to provide further swirling.

Other possible configurations, the containers 20 of which provide more than one pair of attachment branches 30, 30ₐ for the connection to more than two lines 40, 40ₐ are not illustrated.

With the devices 10, 10ₐ described, entirely different powders can be effortlessly mixed in a completely closed manner. In the pharmaceutical sphere, this technology is suitable particularly for the contamination-free handling of active substances, the properties of which must not be changed.

The system comprises—as described—a main container 12, 12ₐ with a deflector 36 installed in its center. A conveying system with two tangential attachment branches 30, 30ₐ as inputs is fitted above the main container 12, 12ₐ. During a suction phase, the butterfly valves 42 of said attachment branches open.

The powders are introduced automatically by a powder-conveying system and are guided in a circulating manner through the main container 12, 12ₐ for a previously precisely determined period of time. In this case, a reflection device ensures a homogeneous distribution of the powder mixture in the main container 12, 12ₐ.

When the two powder jets meet, the mixing effect permits a considerable increase in the speed and efficiency of the mixing. The restricted speed of circulation prevents damage to the particles.

The system can be operated without any problem with oxygen being excluded. This permits even hygroscopic powders, such as powders which can oxidize or explode, to be mixed.

This technology can easily be integrated into a pharmaceutical production line. Powders can automatically be sucked up out of the vessels 54, 55—for example out of barrels, sacks—or directly from process apparatuses, granulators or the like. After the mixing operation is ended, the system can be emptied fully automatically and completely in the next processing step. This system does not contain any movable or rotating mechanical parts, which permits easy automatic cleaning.

FIG. 5 shows a mixing tower 60 with three cylindrical tubes or similar hollow profiles 64 of inner diameter e—which are connected by intermediate chambers 62 and are assigned to a common longitudinal axis B—the lower of which is downwardly closed by a bottom chamber 68 and the topward one of which is upwardly closed by a cover 69.

The diameter f of the chambers 62, 68 is larger than that of the hollow profiles or cylindrical tubes 64. A connecting branch for a supply or removal line is indicated at 70.

The lower mouths 66 of the cylindrical tubes 64 are assigned hot-air generators 72—which are inclined downward at an angle w, of approximately 15°—which ensure that the material circulating through the tube chambers 65 of the mixing tower 60 and an outer line 58 in the conveying direction z dries.

1. A method for pneumatic treatment of powder materials (P, Q) in a container chamber (22), characterized in that two material streams are supplied to the container chamber (22) through at least two supply tubes (40, 40ₐ) and are swirled in the container chamber.

2. The method as claimed in claim 1, characterized in that the two material streams are supplied in opposite directions.

3. The method as claimed in claim 1, characterized in that the material streams (x, y) are supplied approximately tangentially.

4. The method as claimed in claim 1, characterized in that the material streams (x, y) are supplied at approximately the same container height and the tracks thereof are interleaved.

5. The method as claimed in claim 1, characterized in that the material streams (x, y) are conducted in at an angle of inclination (w) to a radial plane (E) of the container (22).

6. The method as claimed in claim 5, characterized in that the material streams (x, y) are introduced in a downwardly inclined manner.

7. The method as claimed in claim 1, characterized in that each of the material streams (x, y) is removed from a common vessel (12, 12ₐ).

8. The method as claimed in claim 1, characterized in that each of the material streams (P, Q) is removed from a separate vessel (54, 55).

9. The method as claimed in claim 7, characterized in that the material streams (x₁, y₁) are introduced from the container chamber (22) into the common vessel (12, 12ₐ) and are removed from the latter together.

10. A method for pneumatic treatment of powder materials in a container chamber (65), characterized in that the material stream is guided through at least two hollow profiles (64) connected axially one behind the other and, in the latter, is guided past at least one temperature-generating device.

11. The method as claimed in claim 10, characterized in that the material stream is heated and dried in the outlet region of the hollow profiles (64).

12. (canceled)

13. A device for pneumatic treatment of powder materials (P, Q) with a container (20) connected to a supply line (40, 40ₐ) and a discharge (23) for the material being conveyed, in particular for carrying out the method as claimed in claim 1, characterized in that at least two supply lines (40, 40ₐ) are provided for a respective material flow and said supply lines are connected to a respective connecting branch (30, 30ₐ, 30_{b}).

14. The device as claimed in claim 13, characterized in that the connecting branches (30, 30ₐ) open in the same direction into the container interior (22).

15. The device as claimed in claim 13, characterized in that the connecting branches (30, 30_{b}) open in opposite directions into the container interior (22).

16. The device as claimed in claim 14, characterized in that the connecting branches (30, 30ₐ or 30, 30_{b}) are arranged at both ends of a common diametric (D).

17. The device as claimed in claim 13, characterized in that at least two connecting branches (30, 30ₐ, 30_{b}) which are approximately parallel to each other are provided on the container (20) and are preferably assigned to a common radial plane (E).

18. The device as claimed in claim 17, characterized in that the connecting branches (30, 30ₐ, 30_{b}) enclose an angle of inclination (w) with the radial plane (E) toward the container axis (A).

19. The device as claimed in claim 18, characterized by an angle of inclination (w) of approximately 10° to 45°, preferably approximately 15°.

20. The device as claimed in claim 18, characterized by connecting branches (30, 30ₐ, 30_{b}) inclined downward toward the container interior (22).

21. The device as claimed in claim 13, characterized in that the connecting branches (30, 30ₐ, 30_{b}) open somewhat offset in height with respect to each other into the container interior (22).

22. The device as claimed in claim 13, characterized in that the container (20) sits with its lower end on a collecting vessel (12, 12ₐ) and is provided at the other end with a connecting branch (28) for flow means.

23. The device as claimed in claim 22, characterized in that the vessel interior (15) of the collecting vessel (12, 12ₐ) is connected in the topward direction to at least one bottom aperture (23) of the container (20) and is provided with a bottomward outflow element (17).

24. The device as claimed in claim 23, characterized in that the bottomward outflow element (17) has at least two output elements (38) for a respective line (40, 40ₐ) connected at the other end to one of the attachment branches (30, 30ₐ).

25. The device as claimed in claim 24, characterized in that the line (40, 40ₐ) connects the outflow element (17) of the collecting vessel (12, 12ₐ) to an attachment branch (30, 30ₐ, 30_{b}).

26. The device as claimed in claim 13, characterized in that a branch line (42, 42ₐ) is connected to the line (40, 40ₐ).

27. The device as claimed in claim 26, characterized in that the branch line (42, 42ₐ) is connected at the other end to a vessel (54, 55) which contains one of the powder materials (P, Q).

28. A device for pneumatic treatment of powder materials (P, Q) with a container (60) connected to a supply line (70) and to a discharge for the material being conveyed, in particular for carrying out the method as claimed in claim 1, characterized in that at least one temperature-generating device (72) crossing the conveying track of the material being conveyed is arranged in the interior (65) of the container (60).

29. The device as claimed in claim 27, characterized in that at least two tubular hollow profiles (64) of uniform cross section are joined axially to each other by an intermediate chamber (62) and a hot-air-generating device (72) is arranged in the intermediate chamber.

30. The device as claimed in claim 28, characterized in that the hot-air-generating device (72) is inclined with respect to the longitudinal axis (B) of the device (60).

31. The device as claimed in claim 28, characterized in that the lower hollow profile (64) ends at a bottom chamber (68) which is connected to the upper hollow profile (64) by a conveying line (58).

32. The device as claimed in claim 31, characterized by at least one more feature which can be gathered from the drawing and/or the description.
